(19) United States
(12) Patent Application Publication
(10) Pub. No.: US 2019/0322867 A1
(43) Pub. Date: Oct. 24, 2019

(54) POLY(ARYLENE SULFIDE) RESIN COMPOSITION AND INSERT-MOLDED ARTICLE

(71) Applicant: Polyplastics Co., Ltd., Tokyo (JP)

(72) Inventors: Katsuhei Ohnishi, Fuji-shi (JP); Tatsuya Kanezuka, Fuji-shi (JP)

(73) Assignee: Polyplastics Co., Ltd., Tokyo (JP)

(21) Appl. No.: 16/466,848

(22) PCT Filed: Nov. 28, 2017
(86) PCT No.: PCT/JP2017/042523

§ 371 Date: Jun. 5, 2019

(30) Foreign Application Priority Data
Dec. 9, 2016 (JP) 2016-239243

(51) Int. Cl. C08L 81/02; C08K 3/013; C08K 7/04; B29C 45/00; C08L 33/06

(52) U.S. Cl. CPC C08L 81/02; C08K 3/013; B29K 2281/04; B29C 45/0001; C08L 33/068; C08K 7/04

(57) ABSTRACT

[Problem] To provide: a polyarylene sulfide resin composition having excellent high- and low-temperature impact properties and excellent low warpage; and an insert-molded article using the resin composition.

[Solution] A polyarylene sulfide resin composition that contains a polyarylene sulfide resin A, an inorganic filler B, and an olefinic copolymer C containing a structural unit derived from an α-olefin and a structural unit derived from a glycidyl ester of an a, p-unsaturated acid, the inorganic filler B containing a fibrous inorganic filler B1 having a different diameter ratio, which is a ratio of the major axis to the minor axis of a cross section perpendicular to the longitudinal direction, of 1.5 or less, and a fibrous inorganic filler B2 having a different diameter ratio of 3.0 or more, the mass ratio B1/B2 of the fibrous inorganic filler B1 and the fibrous inorganic filler B2 being 0.2 or more and 5.0 or less.

### TECHNICAL FIELD

The present invention pertains to a polyarylene sulfide resin composition and an insert-molded article.

### BACKGROUND ART

An insert-molded article is a molded article wherein an insert member comprising a metal or an inorganic solid, etc. is integrally formed with a resin member comprising a thermoplastic resin composition. Insert-molded articles are applied in a wide range of fields such as automobile parts, electrical and electronic parts, OA equipment parts, etc. However, the thermal expansion coefficient or contraction coefficient due to temperature change greatly differs between the metal or the like and the thermoplastic resin composition that constitute the insert-molded article. Therefore, insert-molded articles sometimes break due to temperature changes during use. For this reason, high- and low-temperature impact properties (heat shock resistance) are demanded of insert-molded articles.

Polyarylene sulfide resins are known as resins that have, among thermoplastic resins, comparatively excellent high- and low-temperature impact properties. However, polyarylene sulfide resins have poor toughness and are fragile. Therefore, in cases where the structure of the insert member is complicated and the resin member has sections with large variations in thickness, such as power modules and parts of reactors used in hybrid cars, and in cases where there are large high- and low-temperature variations in the usage environment, such as parts around an engine of a vehicle, the high- and low-temperature impact properties sometimes decrease. As a method for solving these problems, there is a technique wherein a fibrous filler having a flat cross-sectional shape is blended in a polyarylene sulfide resin (patent document 1).

Further, polyarylene sulfide resins are crystalline resins and therefore have so-called anisotropy of the contraction coefficient, wherein the contraction coefficient of the resin in a cooling process differs between the flow direction of the resin and a direction perpendicular thereto. Due to such anisotropy of the contraction coefficient, dimensional accuracy of the obtained insert-molded article sometimes decreases due to the occurrence of warpage, sink, etc. As a method for suppressing sink, there is a technique wherein a fibrous reinforcing filler having a flat cross-sectional shape is blended in a substantially straight-chain polyarylene sulfide resin having a specific Na content and a pH within a specific range (patent document 2).
Patent Document 1: JP 2005-161693 A
Patent Document 2: JP 2006-328291 A

### SUMMARY OF INVENTION

### Technical Problem

The present invention addresses the problem of providing: a polyarylene sulfide resin composition having excellent high- and low-temperature impact properties and excellent low warpage; and an insert-molded article using the resin composition.

### Solution to Problem

In the process of research, the present inventors discovered that, as an inorganic filler to be blended in a polyarylene sulfide resin, by combining and blending fibrous fillers having different diameter ratios that differ from one another, each filler having a predetermined different diameter ratio, it is possible to maintain excellent high- and low-temperature impact properties even when used in a resin member of an insert-molded article having a structure in which high- and low-temperature impact properties readily decrease, and this discovery led to the completion of the present invention.

In other words, the polyarylene sulfide resin composition according to the present invention contains a polyarylene sulfide resin A, an inorganic filler B, and an olefinic copolymer C containing a structural unit derived from an α-olefin and a structural unit derived from a glycidyl ester of an α,β-unsaturated acid, wherein: the inorganic filler B contains a fibrous inorganic filler B1 in which a different diameter ratio, which is the ratio of the major axis to the minor axis of a cross section perpendicular to the longitudinal direction, is 1.5 or less, and a fibrous inorganic filler B2 in which the different diameter ratio is 3.0 or more; and a mass ratio B1/B2 of the fibrous inorganic filler B1 to the fibrous inorganic filler B2 is 0.2 or more and 5.0 or less.

In the present invention, the inorganic filler B preferably further contains a non-fibrous inorganic filler B3. In the present invention, it is preferable that the content of the inorganic filler B is 90 parts by mass or more and 220 parts by mass or less with respect to 100 parts by mass of the polyarylene sulfide resin A, and that the content of the olefinic copolymer C is 3 parts by mass or more and 30 parts by mass or less with respect to 100 parts by mass of the polyarylene sulfide resin A. The content of the copolymer C is more preferably 5 parts by mass or more and 30 parts by mass or less.

In the present invention, it is preferable that the contents of the fibrous inorganic filler B2 and the non-fibrous inorganic filler B3 are each 20 parts by mass or more with respect to 100 parts by mass of the polyarylene sulfide resin A. The average particle diameter of the non-fibrous inorganic filler B3 is preferably 10 μm or more.

The insert-molded article according to the present invention has an insert member formed by using a metal, an alloy, or an inorganic solid, and a resin member covering at least a portion of a surface of the insert member, wherein the resin member was formed using the abovementioned polyarylene sulfide resin composition.

The present invention may be configured so that the resin member has: a fragile portion which extends in a predetermined direction and comprises either or both of a weld section where flow terminals of the resin composition joined one another and a stress concentration section for concentrating stress generated by expansion and contraction; and a gate mark on a surface extending in a substantially perpendicular direction to the direction in which the fragile portion extends.

### Advantageous Effects of Invention

According to the present invention, it is possible to provide: a polyarylene sulfide resin composition having excellent high- and low-temperature impact properties and low warpage; and an insert-molded article using the resin composition.

### BRIEF DESCRIPTION OF DRAWINGS

FIG. 1 is a schematic representation of one embodiment of the insert-molded article, wherein (A) is a perspective view and (B) is a plan view.

FIG. 2 is a schematic representation of a manner in which a welded section is formed.

FIG. 3 explains measurement positions of low warpage.

### DESCRIPTION OF EMBODIMENTS

One embodiment of the present invention is described in detail below. The present invention is not limited to the following embodiment, and may be implemented by making changes, as appropriate, within a range not hindering the effects of the present invention.

Polyarylene Sulfide Resin Composition

A polyarylene sulfide resin composition (hereinafter referred to simply as “resin composition”) is a resin composition comprising a resin having a polyarylene sulfide resin as a main component. “Main component” means being contained in the resin component at 80 mass % or more, 85 mass % or more, or 90 mass % or more. The resin composition according to the present embodiment contains a polyarylene sulfide resin A, an inorganic filler B, and an olefinic copolymer C.

Polyarylene Sulfide Resin A

The polyarylene sulfide resin A is a resin having a repeating unit represented by general formula (I) below.

—(Ar—S)— (I)

(wherein Ar represents an arylene group)

The arylene group is not particularly limited, and examples include: p-phenylene group, m-phenylene group, o-phenylene group, substituted phenylene group, p,p′-diphenylene sulfone group, p,p′-biphenylene group, p,p′-diphenylene ether group, p,p′-diphenylene carbonyl group, naphthalene group, etc. Among the repeating units represented by general formula (I) above, besides a homopolymer using the same repeating unit, the polyarylene sulfide resin A may also be configured as a copolymer comprising heterogeneous repeating units depending on the use.

As a homopolymer, it is preferable to configure so as to have a p-phenylene group as the arylene group and a p-phenylene sulfide group as the repeating unit. A homopolymer having a p-phenylene sulfide group as a repeating unit has extremely high heat resistance and exhibits high strength, high rigidity, and further high dimensional stability in a wide range of temperature regions. By using such a homopolymer, it is possible to obtain a molded article having most excellent physical properties.

As a copolymer, it is possible to use a combination of two or more different arylene sulfide groups from arylene sulfide groups comprising the abovementioned arylene groups. Among these, a combination comprising a p-phenylene sulfide group and an m-phenylene sulfide group is preferred from the perspective of obtaining a molded article having high physical properties such as heat resistance, formability, mechanical properties, etc. A polymer comprising 70 mol % or more of a p-phenylene sulfide group is more preferable, and a polymer comprising 80 mol % or more of the same is even more preferable. It should be noted that the polyarylene sulfide resin A having a phenylene sulfide group is a poly(phenylene sulfide) resin (PPS resin).

Depending on the production method of the polyarylene sulfide resin A, generally, those having a substantially linear molecular structure not comprising a branched or cross-linked structure, and those having a branched or cross-linked structure are known. However, in the present embodiment, all types are effective.

The melt viscosity of the polyarylene sulfide resin A, measured at 310° C. and a shear rate of 1216 sec⁻¹, is preferably 5 Pa·s or more and 50 Pa·s or less, and more preferably 7 Pa·s or more and 40 Pa·s or less. When the melt viscosity is 5 Pa·s or more and 50 Pa·s or less, it is possible to maintain excellent high- and low-temperature impact properties and good flowability.

The method for producing the polyarylene sulfide resin A is not particularly limited and the polyarylene sulfide resin A may be produced by a conventional and publicly known production method. For example, it is possible to produce the polyarylene sulfide resin A by synthesizing a low molecular weight polyarylene sulfide resin A and then rendering to a high molecular weight by polymerization at a high temperature in the presence of a publicly known polymerization aid.

Inorganic Filler B

The inorganic filler B contains a fibrous inorganic filler B1 and a fibrous inorganic filler B2 (hereinafter referred to as “fibrous fillers B1 and B2”) having different diameter ratios that differ from one another and each having a predetermined different diameter ratio.

“Different diameter ratio” means “the major axis of a cross section perpendicular to the longitudinal direction (the longest straight-line distance of a cross section)/the minor axis of the cross section (the longest straight-line distance in the direction perpendicular to the major axis)”. “Fibrous” means a shape having a different diameter ratio of 1 or more and 10 or less, and an aspect ratio of more than 2 and 1500 or less. In the present embodiment, the term “fibrous” is differentiated from the terms “plate-shaped” (shape having a different diameter ratio of more than 10 and an aspect ratio of 1 or more and 1500 or less) and “granular” (different diameter ratio of 1 or more and 10 or less and an aspect ratio of 1 or more and 2 or less) which appear later. It should be noted that these shapes are all initial shapes (shape before melt-kneading). “Aspect ratio” means “the longest straight-line distance in the longitudinal direction/the minor axis of a cross section perpendicular to the longitudinal direction (the longest straight-line distance in the direction perpendicular to the “longest straight-line distance of the cross section”)”. The different diameter ratio and the aspect ratio can both be calculated by using a scanning electron microscope and image processing software.

The present embodiment contains a combination of a fibrous inorganic filler B1 having a different diameter ratio of 1.5 or less and a fibrous inorganic filler B2 having a different diameter ratio of 3.0 or more. Due thereto, even when an insert-molded article has a structure in which the high- and low-temperature impact properties readily decrease, it is possible to produce an insert-molded article having excellent high- and low-temperature impact properties, excellent low warpage, and high dimensional accuracy.

Fibrous Inorganic Filler B1

The fibrous inorganic filler B1 is a fibrous inorganic filler having a different diameter ratio of 1.5 or less, and preferably 1.0 or more and 1.3 or less. By containing an inorganic filler B1 having such a different diameter ratio, it is possible to lower the mold shrinkage rate and the linear expansion coefficient of the insert-molded article and to increase the mechanical properties and the high- and low-temperature impact properties of the same. Examples of the inorganic filler B1 include general fibrous inorganic fillers in which, for example, the cross-sectional shape perpendicular to the longitudinal direction is circular or substantially circular.

From the perspective of further improving ease of production and a reinforcing effect, the cross-sectional area of the fibrous inorganic filler B1 is preferably 1×10⁻⁵ to 1×10⁻³ mm², and more preferably 2×10⁻⁵ to 8×10⁻³ mm². The average length of the fibrous inorganic filler B1 is not particularly limited but considering mechanical properties, moldability, etc. of the molded article, an average fiber length of 50 to 1000 μm is preferable inside the molded article. “Average fiber length” is the average value of the lengths of several dozen fiber pieces. Further, it is possible to use a hollow fiber as the fibrous inorganic filler B1 with an objective of lightening the specific weight of the resin composition, etc.

Examples of a material of the fibrous inorganic filler B1 include: mineral fibers such as glass fiber, carbon fiber, zinc oxide fiber, titanium oxide fiber, wollastonite, silica fiber, silica-alumina fiber, zirconia fiber, boron nitride fiber, silicon nitride fiber, boron fiber, potassium titanate fiber, etc.; and metal fibrous materials such as stainless steel fiber, aluminum fiber, titanium fiber, copper fiber, brass fiber, etc.; and synthetic fibers such as polyamide fiber, high molecular weight polyethylene fiber, aramid fiber, polyester fiber, fluorine fiber, etc. One or two or more of the foregoing may be used. Among the foregoing, glass fiber and carbon fiber are preferable.

The fibrous inorganic filler B1 may be surface-treated using a variety of generally known surface treatment agents such as an epoxy-based compound, an isocyanate-based compound, a silane-based compound, a titanate-based compound, an aliphatic acid, etc. By using a surface treatment, it is possible to improve adhesion with the polyarylene sulfide resin A. The surface treatment agent may be applied in advance to the fibrous inorganic filler B1 before material preparation and administering a surface treatment or a bundling process, or may be added simultaneously with material preparation.

From the perspective of further improving mechanical properties and high- and low-temperature impact properties, the content of the fibrous inorganic filler B1, with respect to 100 parts by mass of the polyarylene sulfide resin A, is preferably 10 parts by mass or more, more preferably 20 parts by mass or more, and 110 parts by mass or less.

Fibrous Inorganic Filler B2

The fibrous inorganic filler B2 is a fibrous inorganic filler having a different diameter ratio 3.0 or more, preferably 3.5 or more, and more preferably 3.8 or more. The upper limit value of the different diameter ratio is 10.0 or less, preferably 8.0 or less, and more preferably 6.0 or less. By containing an inorganic filler B2 having such a different diameter ratio, it is possible to reduce the anisotropy of the mold shrinkage rate and the linear expansion coefficient of the insert-molded article and to improve the low warpage, the mechanical properties, and the high- and low-temperature impact properties of the same. By combining the fibrous inorganic filler B2 with the fibrous inorganic filler B1, it is possible to obtain superior effects in which both high- and low-temperature impact properties as well as low warpage are fulfilled more than when the fibrous inorganic filler B1 is used alone.

Examples of the fibrous inorganic filler B2 include fibrous inorganic fillers in which the cross-sectional shape perpendicular to the longitudinal direction is oval, elliptical, semicircular, cocoon-shaped, rectangular, or a shape similar to the foregoing. It should be noted that “cocoon-shaped” is a shape in which an area near the center of an oval in the longitudinal direction is inwardly sunken.

From the perspective of further improving ease of production and effects of combining with the fibrous inorganic filler B1, the cross-sectional area of the fibrous inorganic filler B2 is preferably 1×10⁻⁵ to 1×10⁻³ mm², and more preferably 1×10⁻⁴ to 5×10⁻⁴ mm². The average length of the fibrous inorganic filler B2 is not particularly limited but considering mechanical properties, moldability, etc. of the molded article, an average fiber length of 50 to 1000 μm is preferable inside the molded article. “Average fiber length” is as described above. The same as for the fibrous inorganic filler B1, it is also possible to use a hollow fiber as the fibrous inorganic filler B2. The material of the fibrous inorganic filler B2 and a surface treatment to be carried out as needed are also the same as for the fibrous inorganic filler B1 described above and are therefore omitted here.

From the perspective of further enhancing effects of combining with the inorganic filler B1 and further improving high- and low-temperature impact properties, the content of the fibrous inorganic filler B2, with respect to 100 parts by mass of the polyarylene sulfide resin A, is preferably 20 parts by mass or more, more preferably 25 parts by mass or more, and 100 parts by mass or less.

The content ratio of the inorganic fillers B1 and B2 is, as a mass ratio B1/B2 of the inorganic fillers B1 and B2, 0.2 or more and 5.0 or less, preferably 0.3 or more and 4.0 or less, more preferably 0.4 or more and 4.0 or less, and even more preferably 0.4 or more and 3.8 or less. By setting B1/B2 to be 0.2 or more and 5.0 or less, it is possible to obtain a resin composition having both excellent high- and low-temperature impact properties and excellent low warpage.

Other Fillers

In order to improve dimensional stability and suppress generation of metallic corrosive gas, etc., besides the inorganic fillers B1 and B2 described above, the inorganic filler B can also contain another inorganic filler, as needed. Examples of other fillers include a non-fibrous inorganic filler B3, and another fibrous inorganic filler B4 in which the different diameter ratio differs from those of the inorganic fillers B1 and B2 described above, etc. It is also possible to carry out a surface treatment on these other fillers in the manner described above.

Examples of the non-fibrous inorganic filler B3 include granular inorganic fillers, plate-shaped inorganic fillers, etc. As described above, it should be noted that: “granular” is a shape having a different diameter ratio of 1 or more and 10 or less and an aspect ratio of 1 or more and 2 or less; and “plate-shaped” is a shape having a different diameter ratio of more than 10 and an aspect ratio of 1 or more and 1500 or less.

Among the non-fibrous inorganic fillers B3, examples of a granular inorganic filler include carbon black, silica, quartz powder, glass beads, glass powder, talc (granular), silicates such as calcium silicate, aluminum silicate, diatomaceous earth, etc., metal oxides such as iron oxide, titanium oxide, zinc oxide, alumina, etc., metal carbonates such as calcium carbonate, magnesium carbonate, etc., metal sulfates such as calcium sulfate, barium sulfate, etc., as well as silicon carbide, silicon nitride, boron nitride, and various kinds of metallic powders, etc. Among these, calcium carbonate and glass beads may be used preferably.

Among the non-fibrous inorganic fillers B3, examples of a plate-shaped inorganic filler include glass flakes, talc (plate-shaped), mica, kaolin, clay, alumina, and various kinds of metallic foils, etc. Among these, glass flakes and talc may be used preferably. Two or more kinds of the inorganic fillers described above may be mixed and used as the non-fibrous inorganic filler B3 with an objective of improving dimensional accuracy and enhancing mechanical properties, etc.

From the perspective of further improving mechanical strength and high- and low-temperature impact properties, in the case of a granular filler, the average particle diameter (50%d) of the non-fibrous inorganic filler B3 in the initial shape (shape before melt-kneading), is preferably 10 μm or more, more preferably 12 μm or more, and even more preferably 15 μm or more. Further, the upper limit value is preferably 50 μm or less, more preferably 45 μm or less, and even more preferably 40 μm or less. In the case of a plate-shaped filler, the average particle diameter in the initial shape (shape before melt-kneading) is preferably 10 μm or more and 1000 μm or less, more preferably 15 μm or more and 900 μm or less, and particularly preferably 20 μm or more and 800 μm or less. It should be noted that the average particle diameter (50%d) means the median diameter which is 50% of an integrated value in a particle size distribution measured by a laser diffraction/scattering method.

From the perspective of further improving mechanical strength and high- and low-temperature impact properties, the blended amount of the non-fibrous inorganic filler B3, with respect to 100 parts by mass of the polyarylene sulfide resin A, is preferably 20 parts by mass or more and more preferably 25 parts by mass or more. In particular, the contents of the fibrous inorganic filler B2 and the non-fibrous inorganic filler B3 described above are preferably each 20 parts by mass or more with respect to 100 parts by mass of the polyarylene sulfide resin A, more preferably 22 parts by mass or more, and particularly preferably 25 parts by mass or more. When the contents of the fibrous inorganic filler B2 and the non-fibrous inorganic filler B3 are each 20 parts by mass or more with respect to 100 parts by mass of the polyarylene sulfide resin A, it is possible to attain excellent high- and low-temperature impact properties even if the insert-molded article has a structure in which high- and low-temperature impact properties readily decrease. From the perspective of suppressing a decrease in mechanical properties, setting the upper limit value of the blended amount of the non-fibrous inorganic filler B3 so that the mass ratio of the same to the polyarylene sulfide resin A is 80 parts by mass or less is preferable, and 65 parts by mass or less is more preferable.

Examples of the other fibrous inorganic filler B4 include fibrous inorganic fillers having a different diameter ratio of 1.6 or more and less than 3.0. The material of the fibrous inorganic filler B4 is the same as for the fibrous inorganic fillers B1 and B2 described above and is therefore omitted here.

From the perspective of realizing an action due to a combination of the inorganic fillers B1 and B2 described above while maintaining characteristics of the polyarylene sulfide resin A, the content of the inorganic filler B, with respect to 100 parts by mass of the polyarylene sulfide resin A, is preferably 90 parts by mass or more and 220 parts by mass or less, more preferably 100 parts by mass or more and 200 parts by mass or less, and particularly preferably 110 parts by mass or more and 180 parts by mass or less.

Olefinic Copolymer C

The olefinic copolymer C contains, as a copolymer component, a structural unit derived from an α-olefin and a structural unit derived from a glycidyl ester of an a, p-unsaturated acid. Since such an olefinic copolymer C is contained, it is possible to remarkably enhance the high- and low-temperature impact properties of the insert-molded article. Among olefinic copolymers, it is preferable that the olefinic copolymer C is an olefinic copolymer containing a structural unit derived from a (meth)acrylic acid ester. An olefinic copolymer may be used singly or by combining two or more types. It should be noted that hereinafter (meth)acrylic acid ester is also referred to as (meth)acrylate. For example, (meth)acrylic acid glycidyl ester is also referred to as glycidyl (meth)acrylate. Further, in the present description, “(meth)acrylic acid” means both acrylic acid and methacrylic acid, and “(meth)acrylate” means both acrylate and methacrylate.

The α-olefin is not particularly limited but examples thereof include ethylene, propylene, butylene, etc. Among these, ethylene is preferable. One or two or more of the above may be selected and used as the α-olefin. The content of the copolymer component derived from the α-olefin is not particularly limited but may, for example, be set as 1 mass % or more and 8 mass % or less in the entire resin composition.

Examples of a glycidyl ester of an a, p-unsaturated acid include those having a structure represented by general formula (II) below.

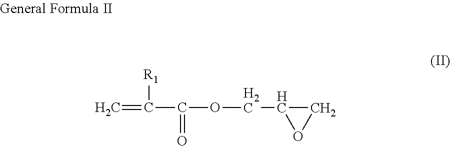

(wherein R1 represents hydrogen or an alkyl group having a carbon number from 1 to 10)

Examples of compounds represented by general formula (II) above include acrylic acid glycidyl ester, methacrylic acid glycidyl ester (GMA), ethacrylic acid glycidyl ester, etc. Among these, methacrylic acid glycidyl ester is preferable. A glycidyl ester of an α,β-unsaturated acid may be used singly or two or more types may be used in combination. The content of the copolymer component derived from a glycidyl ester of an a, p-unsaturated acid is preferably 0.05 mass % or more and 0.6 mass % or less in the entire resin composition. When the content of the copolymer component derived from a glycidyl ester of an α,β-unsaturated acid is in this range, it is possible to further suppress precipitation of mold deposits while also maintaining high- and low-temperature impact properties.

The (meth)acrylate ester is not particularly limited but examples thereof include acrylate esters such as methyl acrylate, ethyl acrylate, n-propyl acrylate, isopropyl acrylate, n-butyl acrylate, n-hexyl acrylate, n-octyl acrylate, etc.; methacrylate esters such as methyl methacrylate, ethyl methacrylate, n-propyl methacrylate, isopropyl methacrylate, n-butyl methacrylate, isobutyl methacrylate, n-amyl methacrylate, n-octyl methacrylate, etc. Among these, methyl acrylate is preferable. A (meth)acrylate ester may be used singly or two or more types may be used in combination. The content of the copolymer component derived from a (meth)acrylate ester is not particularly limited but may, for example, be set to be 0.5 mass % or more and 3 mass % or less in the entire resin composition.

The olefinic copolymer comprising a structural unit derived from an α-olefin and a structural unit derived from a glycidyl ester of an a, p-unsaturated acid, and further, the olefinic copolymer comprising a structural unit derived from a (meth)acrylate ester can be produced by carrying out copolymerization by a conventional and publicly known method. For example, by carrying out copolymerization by a normal and well-known radical polymerization reaction, it is possible to obtain the olefinic copolymers described above. The kind of olefinic copolymer is not particularly limited and may, for example, be a random copolymer and may also be a block copolymer. Further, the olefinic copolymer described above may be an olefin-grafted copolymer in which, for example, polymethyl methacrylate, polyethyl methacrylate, polymethyl acrylate, polyethyl acrylate, polybutyl acrylate, poly(2-ethylhexyl acrylate), polystyrene, polyacrylonitrile, acrylonitrile-styrene copolymer, butyl acrylate-styrene copolymer, etc. are branched or chemically joined in a cross-linked structure to the olefinic copolymer.

The olefinic copolymer used in the present embodiment may contain a structural unit derived from another copolymer in a range that does not hinder the effects of the present invention.

Examples of an olefinic copolymer include, more specifically, a glycidyl methacrylate modified ethylene copolymer, a glycidyl ether modified ethylene copolymer, etc., and among these a glycidyl methacrylate modified ethylene copolymer is preferable.

Examples of the glycidyl methacrylate modified ethylene copolymer include a glycidyl methacrylate grafted modified ethylene copolymer, an ethylene-glycidyl methacrylate copolymer, an ethylene-glycidyl methacrylate-methyl acrylate copolymer, etc. Among these, since it is possible to obtain a particularly excellent metal resin composite molded body, an ethylene-glycidyl methacrylate copolymer and an ethylene-glycidyl methacrylate-methyl acrylate copolymer are preferable, and an ethylene-glycidyl methacrylate-methyl acrylate copolymer is particularly preferable. “BONDFAST” (manufactured by Sumitomo Chemical Co., Ltd.), etc. may be given as a specific example of an ethylene-glycidyl methacrylate copolymer and an ethylene-glycidyl methacrylate-methyl acrylate copolymer.

Examples of the glycidyl ether modified ethylene copolymer include a glycidyl ether grafted modified ethylene copolymer, a glycidyl ether-ethylene copolymer, etc.

From the perspective of suppressing mold deposits while also further enhancing high- and low-temperature impact properties, the content of the olefinic copolymer C, with respect to 100 parts by mass of the polyarylene sulfide resin A, is preferably 3 parts by mass or more and less than 30 parts by mass, more preferably 5 parts by mass or more and-30 parts by mass or less, and even more preferably 10 parts by mass or more and 25 parts by mass or less.

Other Additives, etc.

In order to provide desired properties according to the objective of the resin composition and in a range in which the effects of the present invention are not hindered, the resin composition may have blended therein a publicly-known additive which is generally added to thermoplastic resins and thermosetting resins, that is, a burr inhibitor, a mold release agent, a lubricant, a plasticizer, a flame retardant, a coloring agent such as a dye or a pigment, etc., a crystallization accelerator, a crystal nucleating agent, various kinds of antioxidants, a thermal stabilizer, a weather-resistant stabilizer, a corrosion inhibitor, etc., according to required capabilities. Examples of a burr inhibitor include a branched poly(phenylene sulfide) resin having an extremely high melt viscosity as described, for example, in WO 2006/068161 A and WO 2006/068159 A, and a silane compound, etc. The silane compound includes various kinds of silane compounds such as vinylsilane, methacryloxysilane, epoxysilane, aminosilane and mercaptosilane. Disclosed examples thereof include vinyltrichlorosilane, γ-methacryloxypropyltrimethoxysilane, γ-glycidoxypropyltrimethoxysilane, γ-aminopropyltriethoxysilane and γ-mercaptotrimethoxysilane. However, the silane compounds are not limited thereto. The content of the additive may be set to be, for example, 5 mass % or less of the entire resin composition.

Further, besides the components mentioned above, a small amount of another thermoplastic resin component may be used in combination in a supplementary manner with the resin composition according to the objective thereof. As long as another thermoplastic resin used here is a resin that is stable at high temperatures, any kind of thermoplastic resin may be used. Examples include: aromatic polyesters comprising an aromatic dicarboxylic acid such as polyethylene terephthalate, polybutylene terephthalate, etc. and a diol, or an oxycarboxylic acid, etc.; polyamides; polycarbonates; ABS; polyphenylene oxide; polyalkyl acrylate; polysulfones; polyether sulfones; polyether imides; polyether ketones; fluororesins, etc. Further, two or more of these thermoplastic resins may be mixed and used. The content of the other thermoplastic resin component may be set to be, for example, 20 mass % or less, 15 mass % or less, or 10 mass % or less in the entire resin composition.

The resin composition can easily be prepared by using equipment and a method that are generally used as a conventional method for preparing a resin composition. For example, any of the following may be used: 1) a method in which each component is mixed, kneading and extruding is carried out using a single-screw or twin-screw extruder to prepare pellets, and then molding is performed; 2) a method in which firstly pellets having different compositions are prepared, the pellets are mixed in a predetermined amount and molded, and after molding, a molded article having the target composition is obtained; and 3) a method in which one or more of each component is directly loaded into a molding machine, etc. Further, a method in which a portion of the resin component is made into a fine powder and added to and mixed with the other components, is a preferable method from the perspective that a uniform blend of the components is achieved.

Insert-Molded Article

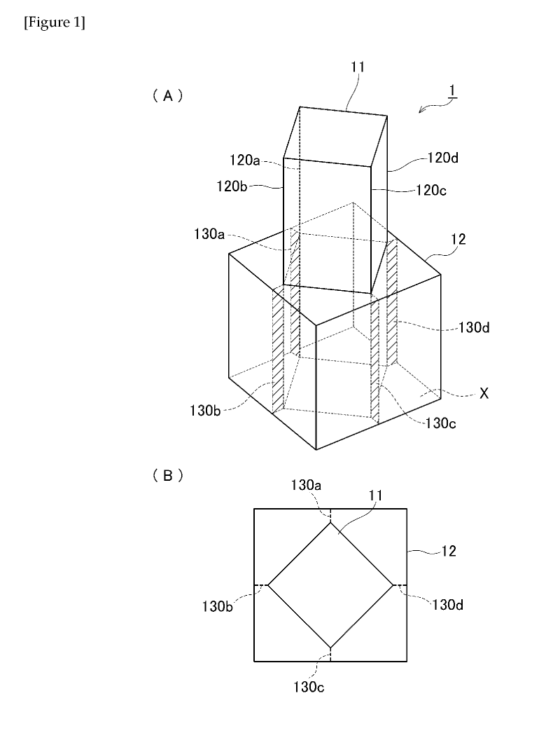

FIG. 1 (A), (B) are schematic representations of one example of an insert-molded article according to the present embodiment. (A) is a perspective view and (B) is a plan view of (A). As shown in FIG. 1 (A), an insert-molded article 1 has an insert member 11 and a resin member 12 covering at least a portion of a surface of the insert member. The insert member 11 is formed from a metal, an alloy, or an inorganic solid, is a rectangular column shape having four corners sections 120a-d, and a portion thereof is embedded in the resin member 12. The resin member 12 is formed from the polyarylene sulfide resin composition described above and has, in four locations, fragile portions 130a-d comprising both a welded section and a stress concentration section. The fragile portions 130a-d are formed in a substantially oblong shape so as to extend in a predetermined direction. It should be noted that the fragile portions 130a-d may have a configuration comprising only one of the welded section and the stress concentration section.

The “stress concentration section” is a section for concentrating stress generated by expansion and contraction of the resin composition. Examples of the stress concentration section include a corner section (corner part), a cut-out section, a flawed section, a through-hole, a thinned-out section, a thin section, a section having large variation in thickness, and a flow mark section, etc. One or more stress concentration sections may be formed. In the insert-molded article 1 shown in FIG. 1 (A), the corner sections 120a-d of the rectangular-column-shaped insert member 11 are arranged to face the side surfaces of the resin member 12. Further, a distance d between the end of the corner sections (sharp corners) of the insert member 11 and the side surfaces of the resin member 12 is approximately 1 mm, and the vicinities thereof are thin stress concentration sections 130a-d. As shown by the shaded regions, the fragile portions 130a-d are configured in a substantially oblong shape from ridge lines of the regions in which the corner sections 120a-d of the insert member 1 are embedded in the resin member 12 to the side surfaces of the resin member 12.

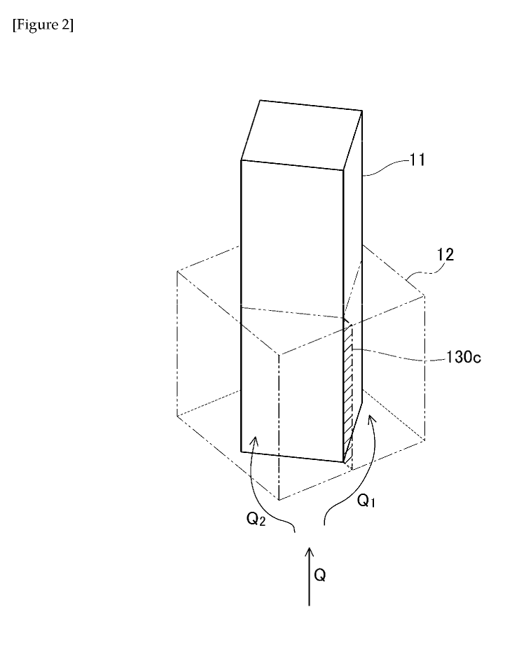

The “welded section” is a section where flow terminals of the resin composition joined (welded) to each other. The welded section tends to have inferior mechanical strength than other locations. The manner in which the welded section is formed is described with reference to FIGS. 1 and 2. The insert-molded article 1 is produced using a mold having a gate in a bottom surface X side and has a gate mark (not shown) on the bottom surface X. As shown in FIGS. 1 and 2, when injection molding the insert-molded article 1, the resin composition is injected into the cavity of the mold from the gate (not shown) of the mold which is on the bottom surface X side of the insert-molded article 1. An injected resin flow Q separates into a plurality of resin flows Q₁, Q₂, with the insert member 11 being the point of origin. The resin flows Q₁, Q₂ each flow along a side surface of the insert member 11 and rejoin one another at a ridge line section of the corner sections 120a-d of the insert member 11, the angle θ₁, θ₂ at which each flow meets the ridge line being less than 90° (for example, 0° or more and 45° or less), and are joined at this interface. These joining sections are the welded sections and constitute the fragile portions 130a-d. It should be noted that for convenience, FIG. 2 shows only the fragile portion 130c but each of the fragile portions 130a-d is formed in an oblong shape from the respective ridge line of the corner sections 120a-d of the insert member 1 to a side surface of the resin member 12. In the insert-molded article 1, the forming location of the welded section and the stress concentration section is the same, and the fragile portions 130a-d are formed so as to comprise both the welded section and the stress concentration section.

The insert-molded article 1 formed in the manner above, has at least one fragile portion 130a-d extending in a predetermined direction and has a gate mark on a surface X extending in a substantially perpendicular direction to the direction in which the at least one fragile portion 130a-d extends. “Substantially perpendicular” includes perpendicular and refers to an angle of approximately 75° to 105°. According to the insert-molded article 1 having a resin member comprising the resin composition according to the present embodiment, even if such a structure is possessed, it is possible to prevent a decrease in high- and low-temperature impact properties and obtain an insert-molded article having excellent high- and low-temperature impact properties. Further, it is possible to enhance dimensional accuracy while simultaneously achieving low warpage.

The metal, alloy, or inorganic solid constituting the insert member 11 is not particularly limited, but should preferably not deform or melt when contacted by the resin during molding. Examples include metals such as aluminum, magnesium, copper and iron, alloys of the above-mentioned metals such as brass, and inorganic solids such as glass and ceramics, and the like.

The method for producing the insert-molded article is not particularly limited, and it is possible to insert-mold the resin composition described above and an insert member that is pre-molded in a desired shape. The insert-molding may be performed, for example, by pre-mounting the insert member in a mold, filling the outside thereof with the resin composition described above by injection molding, extrusion compression molding, etc., and composite-molding. It should be noted that the shape and size of the insert-molded article are not particularly limited.

### EXAMPLES

While the present invention will be explained more specifically by providing examples below, the interpretation of the present invention is not limited by these examples.

### Examples 1-7 and Comparative Examples 1-6

Using the material shown below, the polyarylene sulfide resin, inorganic filler, and olefinic copolymer were dry-blended with the compositions shown in Table 1 at the content ratios shown in the same. By loading the foregoing into a twin-screw extruder at a cylinder temperature of 320° C. and melt-kneading, resin composition pellets of the examples and comparative examples were obtained.

Polyarylene sulfide resin composition A: poly(phenylene sulfide) resin (PPS), “Fortron KPS” manufactured by Kureha Corporation (melt viscosity: 20 Pa·s (shear rate: 1216 sec⁻¹, 310° C.))

Fibrous inorganic filler B1: glass fiber, cross section substantially circular, major axis 10.5 μm, minor axis 10.5 μm, major axis/minor axis ratio 1.0, “Chopped strands ECS 03 T-747H” manufactured by Nippon Electric Glass Co., Ltd.

Fibrous inorganic filler B2: glass fiber, cross section oval, major axis 28 μm, minor axis 7 μm, major axis/minor axis ratio 4.0, “Modified cross section chopped strands CSG 3PA-830” manufactured by Nitto Boseki Co., Ltd.

Fibrous inorganic filler: glass fiber, cross section oval, major axis 20 μm, minor axis 10 μm, major axis/minor axis ratio 2.0, “Modified cross section chopped strands CSG 3PL-962” manufactured by Nitto Boseki Co., Ltd.

Fibrous inorganic filler: glass fiber, cross section cocoon-shaped, major axis 24 μm, minor axis 12 μm, major axis/minor axis ratio 2.0, “Modified cross section chopped strands CSH 3PA-860” manufactured by Nitto Boseki Co., Ltd.

Non-fibrous inorganic filler B3: calcium carbonate, average particle diameter (50%d) 25 μm, “MC-35W” manufactured by Asahi Kohmatsu Co., Ltd.

Olefinic copolymer C: “BONDFAST 7M” manufactured by Sumitomo Chemical Co., Ltd., comprising, as a copolymer component, 67 mass % ethylene, 6 mass % methacrylic acid glicidyl ester, and 27 mass % methyl acrylate.

Evaluation

High- and Low-Temperature Impact Properties

Using the resin compositions obtained in the examples and comparative examples, and an insert member (rectangular column shape of 1.41 cm×1.41 cm×height 2.4 cm) made of S35C as stipulated by JIS G4051: 2005 Carbon steels for machine structural use, and by injection molding under conditions of a cylinder temperature of 320° C. and a mold temperature of 150° C., the resin composition was poured into the mold from a gate in the surface X side in FIG. 1 and insert-injection molded so that the minimum thickness of the resin portion is 1 mm, and thereby the insert-molded article 1 shown in FIG. 1 was produced and used as test pieces.

Using a thermal shock test device (manufactured by Espec Corp.), these test pieces were subjected to repeated cycles of cooling for 1.5 hours at −40° C. followed by heating for 1.5 hours at 180° C., with the fragile portions thereof being observed every 20 cycles. The number of cycles at which cracks formed in the fragile portions was evaluated as an indicator of high- and low-temperature impact properties. The results are shown in Table 1. When the number of cycles is 80 or higher, the high- and low-temperature impact properties are excellent, and when 100 or higher, the high- and low-temperature impact properties are particularly excellent.

Low Warpage

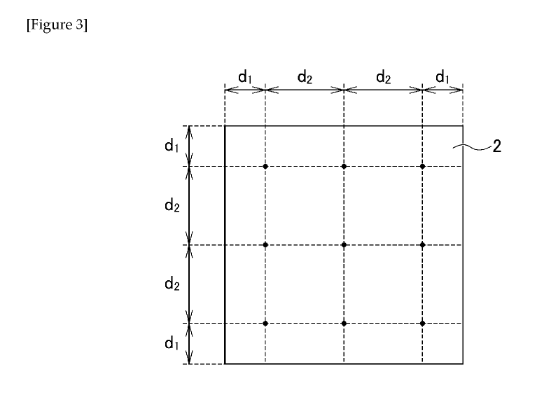

Using the resin compositions obtained in the examples and comparative examples, five 80 mm×80 mm×thickness 1.5 mm flat plate-shaped resin-molded articles 2 were produced by injection molding under the conditions of a cylinder temperature of 320° C., a mold temperature of 150° C., and a holding pressure of 70 MPa. A first flat plate-shaped resin molded article 2 was set on a horizontal surface and using CNC image measuring equipment (model: QVBHU404-PRO1F) manufactured by Mitutoyo Corporation, height from the horizontal surface was measured at nine locations on the flat plate-shaped resin molded article 2 and an average height was calculated from the obtained measurement values. FIG. 3 shows positions where height was measured with a black circle (d₁=3 mm, d₂=37 mm). The height from the horizontal surface described above is the same as the average height described above, and a surface parallel to the horizontal surface mentioned above was set as a reference surface. A maximum height and a minimum height from the reference surface were selected from the heights measured at the nine locations described above and the difference between the maximum and minimum heights was calculated. In the same manner, the abovementioned difference was also calculated for the other four flat plate-shaped resin molded articles, the five values obtained were averaged and this average was set as the warpage amount. The results are shown in Table 1. The lower the warpage amount, the better are the low warpage properties.

TABLE 1

| | Example | Example | Example | Example | Example | Example | Example | Comparative |
|---|---|---|---|---|---|---|---|---|
| Material | 1 | 2 | 3 | 4 | 5 | 6 | 7 | example 1 |
| PPS | 100 | 100 | 100 | 100 | 100 | 100 | 100 | 100 |
| Fibrous inorganic filler | 92 | 100 | 56 | 72 | 40 | 23 | 40 | — |
| B1 (different diameter | | | | | | | | |
| ratio: 1.0) | | | | | | | | |
| Fibrous inorganic filler | 53 | 29 | 42 | 57 | 53 | 47 | 79 | 145 |
| B2 (different diameter | | | | | | | | |
| ratio: 4.0) | | | | | | | | |
| Fibrous inorganic filler | — | — | — | — | — | — | — | — |
| (different diameter ratio: | | | | | | | | |
| 2.0; cross section: oval) | | | | | | | | |
| Fibrous inorganic filler | — | — | — | — | — | — | — | — |
| (different diameter ratio: | | | | | | | | |
| 2.0; crosssection: | | | | | | | | |
| cocoon-shaped) | | | | | | | | |
| Non-fibrous inorganic | — | 37 | 56 | 37 | 53 | 47 | 26 | — |
| filler B3 | | | | | | | | |
| Olefin copolymer C | 16 | 17 | 14 | 17 | 16 | 14 | 16 | 16 |
| B1/B2 | 1.8 | 3.5 | 1.3 | 1.3 | 0.8 | 0.5 | 0.5 | — |
| Total amount of filler | 145 | 166 | 154 | 166 | 145 | 117 | 145 | 145 |
| High- and low-temperature | 120 | 130 | 150 | 120 | 180 | 200 | 200 | 40 |
| shock properties (Cycles) | | | | | | | | |
| Low warpage (mm) | 0.04 | 0.05 | 0.04 | 0.03 | 0.03 | 0.04 | 0.03 | 0.01 |

| | Comparative | Comparative | Comparative | Comparative | Comparative |
|---|---|---|---|---|---|
| Material | example 2 | example 3 | example 4 | example 5 | example 6 |
| PPS | 100 | 100 | 100 | 100 | 100 |
| Fibrous inorganic filler | 145 | 92 | 92 | — | 92 |
| B1 (different diameter | | | | | |
| ratio: 1.0) | | | | | |
| Fibrous inorganic filler | — | — | — | — | 13 |
| B2 (different diameter | | | | | |
| ratio: 4.0) | | | | | |
| Fibrous inorganic filler | — | 53 | — | — | — |
| (different diameter ratio: | | | | | |
| 2.0; cross section: oval) | | | | | |
| Fibrous inorganic filler | — | — | 53 | 102 | — |
| (different diameter ratio: | | | | | |
| 2.0; crosssection: | | | | | |
| cocoon-shaped) | | | | | |
| Non-fibrous inorganic | — | — | — | 102 | 40 |
| filler B3 | | | | | |
| Olefin copolymer C | 16 | 16 | 16 | 5 | 16 |
| B1/B2 | — | — | — | — | 7.0 |
| Total amount of filler | 145 | 145 | 145 | 203 | 145 |
| High- and low-temperature | 150 | 80 | 70 | 30 | 150 |
| shock properties (Cycles) | | | | | |
| Low warpage (mm) | 0.8 | 0.5 | 0.5 | 0.06 | 0.7 |

Unit of content is parts by mass

### REFERENCE SIGNS LIST

1 Insert-molded article

2 Flat plate-shaped resin molded article

11 Insert member

12 Resin member

120a-d Corner section

130a-d Fragile portion

Q Resin flow

1. A polyarylene sulfide resin composition, wherein:
the polyareylene sulfide resin composition contains a polyarylene sulfide resin A, an inorganic filler B, and an olefinic copolymer C that contains a structural unit derived from an α-olefin and a structural unit derived from a glycidyl ester of an α,β-unsaturated acid;
the inorganic filler B contains a fibrous inorganic filler B1 having a different diameter ratio of 1.5 or less, and a fibrous inorganic filler B2 having a different diameter ratio of 3.0 or more, the different diameter ratio being the ratio of the major axis to the minor axis of a cross section perpendicular to the longitudinal direction; and
a mass ratio B1/B2 of the fibrous inorganic filler B1 and the fibrous inorganic filler B2 is 0.2 or more and 5.0 or less.

2. The polyarylene sulfide resin composition according to claim 1, wherein the inorganic filler B further contains a non-fibrous inorganic filler B3.

3. The polyarylene sulfide resin composition according to claim 1, wherein:
the content of the inorganic filler B is 90 parts by mass or more and 220 parts by mass or less with respect to 100 parts by mass of the polyarylene sulfide resin A; and
the content of the olefinic copolymer C is 3 parts by mass or more and 30 parts by mass or less with respect to 100 parts by mass of the polyarylene sulfide resin A.

4. The polyarylene sulfide resin composition according to claim 2, wherein
the contents of the fibrous inorganic filler B2 and the non-fibrous inorganic filler B3 are each 20 parts by mass or more with respect to 100 parts by mass of the polyarylene sulfide resin A.

5. The polyarylene sulfide resin composition according to claim 2, wherein the non-fibrous inorganic filler B3 has an average particle diameter of 10 μm or more.

6. An insert-molded article having an insert member and a resin member covering at least a portion of a surface of the insert member, wherein:
the insert member is formed using a metal, an alloy, or an inorganic solid; and
the resin member is formed using the polyarylene sulfide resin composition according to claim 1. (Original) The insert-molded article according to claim 6, wherein the resin member has:
at least one fragile portion that extends in a predetermined direction and comprises either or both of a welded section where flow terminals of the resin composition joined one another and a stress concentration section for concentrating stress generated by expansion and contraction; and
a gate mark on a surface extending in a substantially perpendicular direction to the direction in which the at least one fragile portion extends.
